(19) United States
(12) Patent Application Publication
(10) Pub. No.: US 2026/0339645 A1
(43) Pub. Date: Oct. 29, 2026

(54) APPLICATION PROGRAMMING INTERFACE VERSION DETECTION AND UPGRADE

(71) Applicant: PAYPAL, INC., San Jose, CA (US)

(72) Inventors: Elena Polyak, Kfar-Saba (IL); Joel Isaac Benchitrit, Ra'anana (IL); Noam Zunsztern, Givatayim (IL); Ben Rahamim, Ashdod (IL)

(21) Appl. No.: 19/188,572

(22) Filed: Apr. 24, 2025

(51) Int. Cl. G06F 8/65; G06F 9/54

(52) U.S. Cl. CPC G06F 8/65; G06F 9/547

(57) ABSTRACT

A computer-implemented method includes receiving, by a computing system associated with a web service, an application programming interface (API) call within the web service originating from a user source, determining, by the computing system based on the received API call, a version of the API in use by the user, determining, by the computing system, that a newer version of the API is available, and in response to determining the version of the API in use by the user and to determining that the newer version of the API is available, automatically causing the user to upgrade to the newer version of the API.

### TECHNICAL FIELD

This disclosure relates to determining and upgrading versions of application programming interfaces in use for accessing web services.

### BACKGROUND

A given web service may have many application programming interface (API) access points, such as websites, various mobile applications, etc. Different proprietors that use the APIs to access the web service may use different versions of API with respect to one another. Further, a given proprietor may use a given API on a number of different environments or platforms, and/or may use different API versions across different systems.

### BRIEF DESCRIPTION OF THE DRAWINGS

FIG. 1 is a block diagram view of an example system for detecting and upgrading application programming interface versions.

FIG. 2 is a flow chart illustrating an example method of detecting and upgrading application programming interface versions.

FIG. 3 is a flow chart illustrating an example method of detecting and upgrading application programming interface versions.

FIG. 4 is a block diagram of an example computing system.

### DETAILED DESCRIPTION

Multiplicity of API versions, and inconsistent use of API versions by a given proprietor user across its platforms or systems, can result in overly burdensome support and maintenance obligations for the provider of the web service accessed by the API as well as inconsistent and sub-optimal access to the functionality of the web service via usage of outdated APIs. Further, web service providers generally do not comprehensively track API versions that are in use, and the proprietor user systems that use those versions, which can result in inadvertent cancellation of a proprietor’s access to the web service when the old API version in use by the proprietor user system reaches end of life.

Known API version issues can be improved upon through the use of automated tracking and upgrading of API versions according to the present disclosure. Such functionality may be thought of as a “virtual assistant” that assists developers in upgrading their API versions. The virtual assistant may use various data sources, such as documentation from the development kit for the API, contents of API calls, a registry of system configuration information of proprietor systems, support tickets (e.g., within the entity that provides the web service) related to installation or use of the API, public forum posts related to installation or use of the API, etc., to determine proprietors using the API, the versions of the API being used, and/or how upgrades of the API versions should be performed.

Using these data points, the virtual assistant may use a trained LLM to generate content for a proactive communication to the proprietor’s developer to cause the proprietor to upgrade its API version or to otherwise automatically cause the API version used by the proprietor system to be upgraded. The generated communication may identify the current API and the environment/platform being used, benefits of updating, and steps to perform the update (e.g., upgrade instructions).

The virtual assistant may also include a chat bot for use by developers. The bot may identify problems and generates solutions, instructions, code, etc. to assist in upgrading an API version. The bot may use information from the proactive upgrading email as part of the input to identify these potential problems and generate solutions. The LLM for this chat bot may be fine-tuned using the data noted above to reduce issues such as hallucinations.

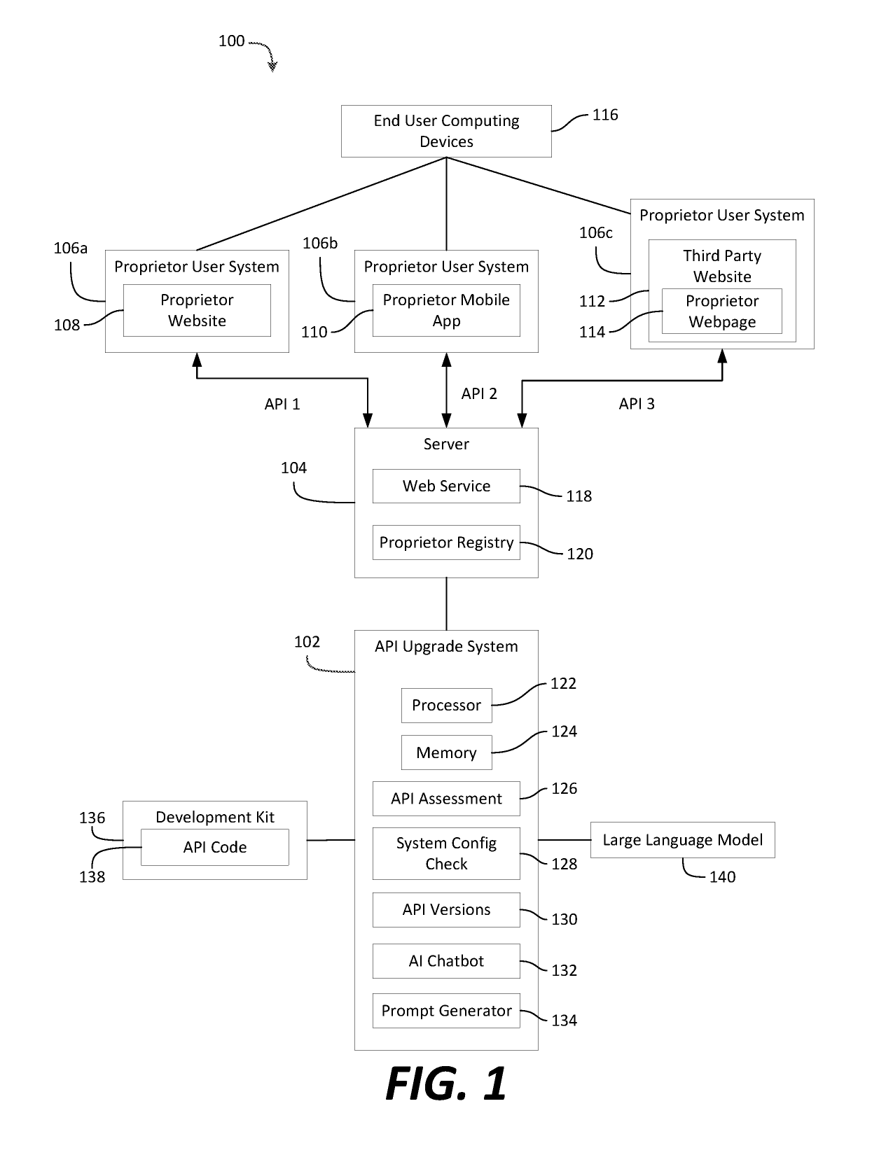

Referring to the drawings, wherein like numerals refer to the same or similar features in the various views, FIG. 1 is a block diagram view of an example system 100 that includes an application programming interface (API) upgrade system 102, a server 104, and a plurality of proprietor user systems 106a, 106b, 106c that may be accessed by end user computing devices 116.

Generally, the proprietor user systems 106 may provide various computing services that are accessible to end user computing devices. Through the proprietor user systems, end users may engage in computing actions such as file transfers, browsing item webpages and listings, communicating with other users, engaging in transactions with the proprietors, and so on. One or more APIs may provide one or more functions to or for the end users. As as will be described below, such APIs may be stored for execution and access on proprietor user systems 106, and those APIs may be upgraded from time to time via the API upgrade system.

A first proprietor user system 106a may include a proprietor website 108. For example, the proprietor website 108 may be accessed by end user computing devices 116 at the proprietor’s domain. The proprietor may be responsible for the content on and services offered through the proprietor website 108, including all of the pages of the proprietor website 108. The proprietor may directly host the proprietor website 108 (e.g., on hardware operated by the proprietor), or may engage a cloud or other third party hosting service to host the proprietor website 108. Accordingly, the first proprietor user system 106a may be or may include the servers and other computing hardware that support the proprietor website 108, where an API may be stored for offering a particular function on the proprietor website 108.

A second proprietor user system 106b may include a proprietor mobile application 110. For example, the proprietor mobile app 110 may be installed on end user computing devices 116 and supported by servers operated by or engaged by the proprietor. The proprietor may be responsible for the content on and services offered through the proprietor mobile app 110. Accordingly, the second proprietor user system 106b may be or may include the servers and other computing hardware that support the proprietor mobile app 110, where an API may be stored for offering a particular function on the proprietor mobile app.

A third proprietor user system 106c may include a third party website 112 that includes a proprietor webpage 114. For example, the third party website 112 may be accessed by end user computing devices 116 at the a third party’s domain, not the proprietor’s domain. The proprietor may be responsible for the content on and services offered through the proprietor webpage 114, but not the other pages of the third party website 112. The third party may host the third party website (e.g., on hardware operated by the third party), or may engage a cloud or other hosting service to host the third party website. Accordingly, the third proprietor user system 106c may be or may include the servers and other computing hardware that support the third party website 112, where an API may be stored for offering a particular function on the proprietor webpage.

Each of the proprietor user systems 106 may utilize an API to access a common web service 118 hosted by the server 104. For example, the first proprietor user system 106a may use a first API (labelled as API 1 in FIG. 1), the second proprietor user system 106b may use a second API (API 2), and the third proprietor user system 106c may use a third API (API 3). For example, the web service 118 may be a user authentication service, a file transfer service, a payment service, a social media service, a map or other location service, a cloud or storage service, a communication service (e.g., chat, messaging, videoconferencing, etc.), a search service, a media display or recording service, a machine learning service, etc. When the API is invoked by a proprietor user system 106, the proprietor user system may make calls to the server 104 via the API to provide the web service 118 in the user interface accessed by the end user computing devices 116 via the proprietor user system 106.

The server 104 may maintain a proprietor registry 120 that includes identities and system information respective of each proprietor that accesses the web service 118 via an API. The system information may include, for example, hardware and operating environment information respective of the proprietor user system 106, a version of the API installed on each proprietor user system 106, access records respective of the proprietor user system 106 (e.g., indicative of API usage volume and patterns), and other system data that may be relevant for determining an appropriate or best version of the API for the proprietor user system 106 to access the web service 118. In some embodiments, system information may be included in API calls received by the server 104 from the proprietor user systems 106. Additionally or alternatively, system information may have been collected for or by the server 104 from a proprietor user system 106 when the proprietor user system 106 downloaded or installed the API, and/or when the proprietor user system 106 registered itself with the server 104 in order to use the web service 118.

The API upgrade system 102 may include a processor 122 and a non-transitory, computer-readable memory 124 storing instructions that, when executed by the processor 122, cause the API upgrade system 102 to perform one or more of the methods, operations, algorithms, etc. of this disclosure. The API upgrade system 102 may include a plurality of functional modules 126, 128, 130, 132, 134 that may be embodied in hardware and/or software. In some embodiments, one or more of the functional modules 126, 128, 130, 132, 134 may be embodied as instructions in the memory 124.

The system 100 may also include a development kit 136 that includes one or more versions of API code 138 for the API and a large language model (LLM) 140. The development kit 136 may be maintained by the same entity that offers the web service 118. The LLM 140 may be or may include, a META LLAMA large language model (LLM), an OPENAI GPT LLM, GOOGLE GEMINI LLM, or other appropriate model. As will be described below, the development kit 136 and LLM 140 may be accessed by the API upgrade system 102 to assist proprietor users in upgrading API versions.

The API upgrade system 102 may include an API assessment module 126 that examines API calls received by the server 104 to determine the version of the API that made the call and to determine if a more recent version of the API exists, by referencing the API versions module 130.

The API upgrade system 102 may include a system configuration check module 128 that may parse one or more receive API calls and may refer to the API call and/or the proprietor registry 120 to determine system configuration information respective of the proprietor user system 106 that made the call. The system configuration check module 128 may, in conjunction with the API assessment module 126, determine if any newer-available API versions are compatible with, or recommended for, the system configuration of the proprietor user system 106.

The API versions module 130 may store, or may access, a list or other store of versions of the API. The list of versions may include versions that update over time as well as versions for different platforms (e.g., a website, a mobile application, or other interface type). The API versions module 130 may also store or access, for each API version, a date of publication and a set of system requirements (e.g., minimum system capabilities) and/or a set of recommended system specifications for execution of the API version.

The API upgrade system 102 may include an AI chatbot module 132 that receives chat messages from a proprietor user and, in conjunction with the LLM 140, generates responses to the proprietor user. The AI chatbot may be invoked when a proprietor user, such as a developer affiliated with a proprietor, accesses a domain associated with the API for support related to the API or related services or functionality. The AI chatbot may inform the developer about upgraded version availability, assist the proprietor user developer with installation of a new API version, assist the proprietor user developer with use of a newly-installed API version, and provide other support functionality.

The API upgrade system 102 may include a prompt generator module 134 that generates prompts to the LLM 140 to cause the LLM 140 to generate, for example, instructions for a developer user to install an API upgrade. The prompt generator module 134 may include in the instructions, for example, the current API version used on the proprietor system to be upgraded, the upgraded API version to be installed, system information respective of the proprietor system 106. The prompt generator module 134 may also include in the prompt code respective of the current API version used on the proprietor system and/or code respective of the API version to be installed. The prompt generator module 134 may include in the prompt an instruction for the LLM 140 to generate installation instructions, for the LLM 140 to generate code revision instructions, and/or other installation help.

In some embodiments, the prompt generator module 134 may refer to additional internal and/or external sources for information useful to developing installation instructions. For example, the prompt generator module 134 may search for, and pass to the LLM 140, internal support ticket records related to installation of and/or errors in the API that is to be installed on the proprietor user system 106. Additionally or alternatively, the prompt generator module 134 may search for, and pass to the LLM 140, external public forum posts related to installation of and/or errors in the API that is to be installed on the proprietor user system 106.

The prompt generator module 134 may also generate prompts to the LLM 140 to support the AI chatbot module 132. For example, the prompt generator module 134 may generate prompts to the LLM 140 based on input text from the proprietor user, combined with data respective of the proprietor user, the context of the proprietor user’s input, and other information to assist the LLM 140 in generating a support response.

In operation, a proprietor user system 106 may communicate with the server 104. The communication may be, for example, an API call to the web service 118, an invocation of a chatbot, an explicit request to upgrade the API used by the proprietor user system 106, and/or another electronic communication. Details of the communication, including its contents and metadata, may be transmitted by the server 104 and received by the API upgrade system 102. Based on the communication, the API upgrade system 102 may determine a current version of the API for the web service 118 in use by the proprietor user system 106 (e.g., because a version identifier is explicitly included in the communication, by review of proprietor installation records in the proprietor registry 120, by comparing details of the communication to API version formats, etc.). The API upgrade system 102 may further determine whether an upgraded API version is available based on the current version, the proprietor system configuration, and the API version information. When the API upgrade system 102 determines that an upgraded API version is available for the proprietor system 106, the API upgrade system 102 may communicate with the LLM 140 to generate installation instructions for a proprietor user developer, and may transmit the installation instructions with the upgraded API file or files to the proprietor developer user to cause the proprietor system 106 to upgrade its API version.

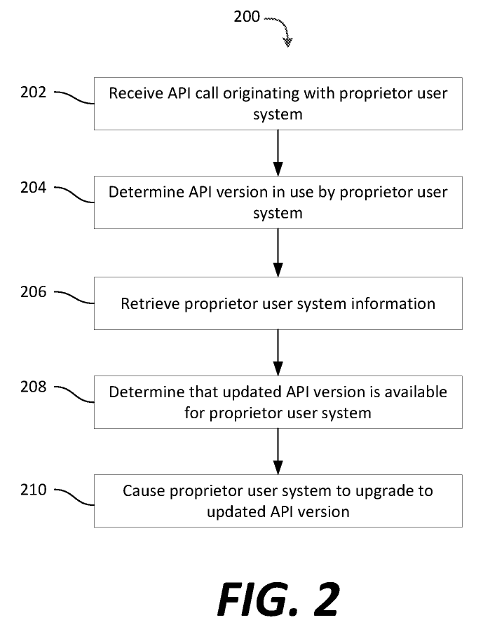

FIG. 2 is a flow chart illustrating an example method 200 of detecting and upgrading application programming interface versions. The method 200, or one or more portions of the method 200, may be performed by the API upgrade system 102, and thus the method 200 may be computer-implemented.

The method 200 may include, at operation 202, receiving an API call that originates from a proprietor user source, such as a proprietor user system, within a web service. The web service may be available to the proprietor user system to support user interfaces in multiple channels, such as a proprietor website, a proprietor mobile application, a proprietor webpage on a third party website, etc. The API call may be received by the web service via a first channel of the multiple channels, where the first channel supports a first user interface (e.g., the proprietor website) for an end user, a second channel supports a second user interface (e.g., the proprietor mobile application), and a third channel supports a third user interface (e.g., a proprietor webpage on a third-party website). For example, the API may be for integrating the web service into a proprietor webpage operated by a proprietor user.

The method 200 may further include, at operation 204, determining, based on the received API call, a version of the API in use by the proprietor user system. In some embodiments, operation 204 may include determining the API version based on a version identifier included in the API call. In some embodiments, operation 204 may include determining the API version by comparing the format or content of the API call to required formats or contents of various versions of the API. In some embodiments, operation 204 may include retrieving configuration information respective of the proprietor user system (e.g., from a proprietor registry), which configuration information may include one or more API versions in use by the proprietor user system, API installation records respective of the proprietor user system, and the like.

The method 200 may include, at operation 206, retrieving or otherwise determining system information respective of the user (e.g., of the proprietor user system) from a registry of the web service. The retrieved system information may include, for example, operating system information, domain information, version information of a website of the proprietor from which the API is used, information respective of the processing and memory resources of the system, and the like.

The method 200 may further include, at operation 208, determining that a newer version of the API is available based on the determined current API version from operation 204 and, in some embodiments, based on the retrieved system information from operation 206. In some embodiments, determining that a newer version of the API is available may include determining that a newer version of the API that is compatible with the system information is available. In some embodiments, operation 208 may include retrieving or otherwise referring to a list of API versions, the release dates of those API versions, system requirements of those API versions, etc.

In some embodiments, operation 208 may include determining, based on the retrieved system information of the proprietor user system, an installation procedure for the newer version of the API. For example, determining the installation procedure may include generating a prompt to an LLM based on the determined system information and receiving the installation procedure as output from the LLM.

Operation 208 may include, in some embodiments, determining a set of functional differences between a newer version of the API and the version of the API in use by the proprietor user system. For example, determining the set of functional differences may include retrieving a set of version notes respective of the newer version, which version notes may identify new functionality. Still further, determining the set of functional differences may include retrieving a plurality of sets of version notes respective of a plurality of newer versions relative to the version in use by the proprietor user system, where each set of version notes may identify new functionality relative to the previous version, and compiling the functional differences from the multiple version notes.

The method 200 may include, at operation 210, in response to determining the version of the API in use by the user and to determining that the newer version of the API is available, automatically causing the user to upgrade to the newer version of the API. In some embodiments, operation 210 may include transmitting a download package to the proprietor user system that automatically installs the upgraded API version. In some embodiments, operation 210 may include automatically prompting a proprietor developer user to download an installation package for the upgraded API version (e.g., by automatically generating and transmitting an email, in-application message, etc. with a prompt to the developer user). In some embodiments, a transmission of the download package or the prompt to the proprietor developer may be automatic in response to the API call received at operation 202. Alternatively, a transmission of the download package or the prompt to the proprietor developer may be automatic in response to another communication from a proprietor user, such as a request for an API upgrade or a request for support submitted through a chatbot. In some embodiments, operation 210 may include transmitting an installation procedure for the upgraded API version to the user. In some embodiments, operation 210 may include automatically opening a chatbot window on the user interface and prompting the user to ask the chatbot questions to learn how to install the upgraded API. The chatbot may then function as disclosed herein.

Where functional differences between the user’s current API version and a newer version were determined at operation 208, causing the user to upgrade to the newer version of the API at operation 210 may be further in response to determining the set of functional differences. For example, where the set of functional differences is more than zero, the method may include causing the user to upgrade to the newer version of the API. In contrast, where the newer API version is functionally identical to the API version in use by the proprietor user system, then the user may not be caused to upgrade.

In some embodiments, the method 200 may further include determining a second channel for accessing the web service that is compatible with the proprietor user system information. For example, a first proprietor user system may have submitted the API call at operation 202, and the determined proprietor user system information at operation 206 may include information respective of another proprietor user system, separate from the one that submitted the API call, that could access or does access the web service. The method 200 may include also evaluating that second proprietor user system for upgrade or original installation of the same API according to operation 208 and automatically causing the user to install an API for making call to the web service via the second channel.

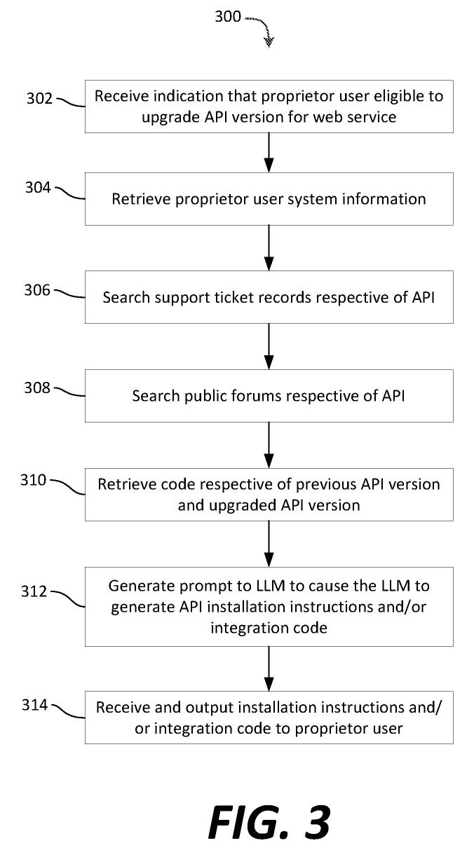

FIG. 3 is a flow chart illustrating an example method 300 of detecting and upgrading application programming interface versions. The method 300, or one or more portions of the method 300, may be performed by the API upgrade system 102, and thus the method 300 may be computer-implemented.

The method 300 may include, at operation 302, receiving an indication that a proprietor user is eligible to upgrade a version of an application programming interface (API) for a web service. In some embodiments, the API may be for integrating the web service into a webpage of the proprietor user. In some embodiments, the API may be for integrating the web service into a third party network platform. The indication may be, for example, an API call from a proprietor user system, a request for an upgraded version from the user via a chatbot or other communication channel.

The method 300 may include, at operation 304, automatically retrieving system information respective of the user. For example, the retrieved system information may include configuration information respective of the proprietor user system that is eligible for an API version upgrade.

The method 300 may include, at operation 306, automatically retrieving internal support ticket records respective of the API version. The support ticket records may have been opened by or within an entity performing the method 300 (e.g., an entity that provides the web service to which the API gives access). Each support ticket records may detail a proprietor user’s support need relative to the API, such as a request for installation support or a request to resolve an error. Each support ticket record may also include resolution information for each request, such as whether or not the request was resolved and, if so, what action was taken that resolved the request. In some embodiments, one or more (e.g., each) support tickets may also include unsuccessful resolution attempts, i.e., what action was taken that did not resolve the request. The support ticket records retrieved at operation 306 may be proprietary to the entity that provides the web service to which the API gives access, and thus may not be publicly available.

The method 300 may include, at operation 308, automatically retrieving public forum posts respective of the API version. The public forum posts may be on known forums such as GITHUB®, STACK OVERFLOW®, and other software developer or similar topic forums. Operation 308 may include, for example, automatically generating one or more search queries (e.g., where each search query may include an identifier of the API and/or the API version), automatically navigating to one or more public forum posts, automatically entering the search query or queries on the forum interface, and automatically collecting the search results from the forum.

The method 300 may include, at operation 310, automatically accessing a codebase respective of the API version. For example, operation 310 may include retrieving the complete code of the current API version in use by the proprietor user system and/or of a new version of the API to which the proprietor user system can be upgraded. Additionally or alternatively, operation 310 may include retrieving code that invokes an installer for the new API version.

The method 300 may include, at operation 312, automatically generating a prompt to a large language model (LLM) based on the system information and the API version to cause the LLM to generate installation instructions for the API version. Accordingly, the prompt may include the system configuration information respective of the proprietor user system, as well as indications of the in-use API version and the new API version to be installed. The prompt may include, in some embodiments, internal support ticket records, public forum posts, and/or code obtained at operations 306, 308, 310. Thus, in some embodiments, automatically generating the prompt may be based on retrieved internal support ticket records, based on retrieved public forum posts, and/or based on code from the codebase. The prompt may include an instruction for the LLM to generate installation instructions for the upgraded API version. In some embodiments, the prompt may include an instruction for the LLM to generate integration code that could be used by a developer to add the upgraded API to the proprietor user system.

In some embodiments, the method 300 may include determining one or more third party network platforms through which the user accesses the web service via the API. The third party network platform may be, for example, a third party website on which the proprietor user has a dedicated webpage. Alternatively, the third-party network platform may be a third party mobile application on which the proprietor user has a dedicated section or page. In such embodiments, generating the prompt at operation 312 may be further based on the one or more third party network platforms. For example, operation 304 may include retrieving system configuration information respective of the third party network system and that system configuration information may be a basis for the prompt, operation 306 may include retrieving internal support ticket records respective of an API version that is compatible with the third party network system, and those support ticket records may be a basis for the prompt, operation 308 may include automatically retrieving public forum posts respective of the API version and that mention the third-party platform, and those posts may be a basis for the prompt. Additionally or alternatively, the prompt may identify the third-party platform as the implementation environment for the API.

The method 300 may include, at operation 314, receiving, from the LLM, in response to the prompt, installation instructions, and outputting the installation instructions via the user interface in response to receiving the indication at operation 302. In some embodiments, the user interface is or includes a chat interface. In some embodiments, operation 314 may further include facilitating a feedback loop between the user and the LLM to assist the user in installing the API version. For example, in response to the output of the installation instructions, the user may enter a further request (e.g., in a chatbot interface) for clarification on one or more aspects of the installation instructions. In response, operation 314 may include generating a follow-up prompt to the LLM based on the user’s further request, generating a user-readable output based on the output of the LLM, and outputting the user-readable output in response to the user’s further request. The user may then provide another further request, and so on.

In some embodiments, operation 314 may include generating the user interface associated with the web service in order to perform the output. For example, when a proprietor user system submits an API call, operation 314 may include, in response, generating and causing the proprietor user system to output a new tab, window, interface portion, etc. that provides the web service accessed by the API, and the output may be provided in that interface.

In some embodiments, various operations of FIGS. 2 and 3 may be used in combination. For example, the proprietor user system may transmit an API call and, in response, the upgrade determination operations of the method 200 may be performed, the upgrade instruction generation operations of the method 300 may be performed, and the upgraded API files may be output to the proprietor user system along with installation instructions as described in the methods 200, 300.

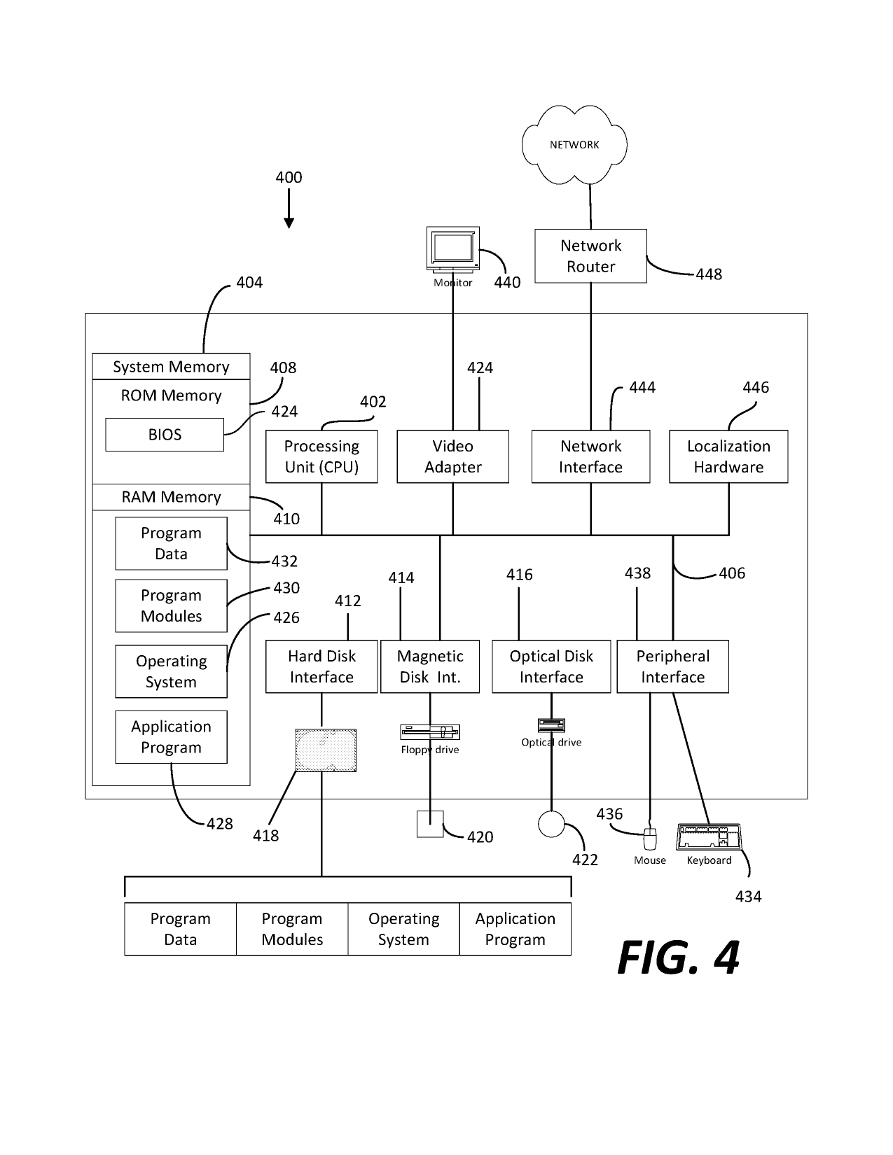

FIG. 4 is a block diagram of an example computing system 400, such as a desktop computer, laptop, smartphone, tablet, or any other such device having the ability to execute instructions, such as those stored within a non-transient, computer-readable medium. Furthermore, while described and illustrated in the context of a single computing system 400, those skilled in the art will also appreciate that the various tasks described hereinafter may be practiced in a distributed environment having multiple computing systems 400 linked via a local or wide-area network in which the executable instructions may be associated with and/or executed by one or more of multiple computing systems 400.

In its most basic configuration, computing system environment 400 typically includes at least one processing unit 402 and at least one memory 404, which may be linked via a bus 406. Depending on the exact configuration and type of computing system environment, memory 404 may be volatile (such as RAM 410), non-volatile (such as ROM 408, flash memory, etc.) or some combination of the two. Computing system environment 400 may have additional features and/or functionality. For example, computing system environment 400 may also include additional storage (removable and/or non-removable) including, but not limited to, magnetic or optical disks, tape drives and/or flash drives. Such additional memory devices may be made accessible to the computing system environment 400 by means of, for example, a hard disk drive interface 412, a magnetic disk drive interface 414, and/or an optical disk drive interface 416. As will be understood, these devices, which would be linked to the system bus 406, respectively, allow for reading from and writing to a hard disk 418, reading from or writing to a removable magnetic disk 420, and/or for reading from or writing to a removable optical disk 422, such as a CD/DVD ROM or other optical media. The drive interfaces and their associated computer-readable media allow for the nonvolatile storage of computer readable instructions, data structures, program modules and other data for the computing system environment 400. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 400.

A number of program modules may be stored in one or more of the memory/media devices. For example, a basic input/output system (BIOS) 424, containing the basic routines that help to transfer information between elements within the computing system environment 400, such as during start-up, may be stored in ROM 408. Similarly, RAM 410, hard drive 418, and/or peripheral memory devices may be used to store computer executable instructions including an operating system 426, one or more applications programs 428, other program modules 430, and/or program data 432. The program modules 430 may include, for example, one or more of the functional modules 126, 128, 130, 132, 134.

An end-user may enter commands and information into the computing system environment 400 through input devices such as a keyboard 434 and/or a pointing device 436. While not illustrated, other input devices may include a microphone, a joystick, a game pad, a scanner, etc. These and other input devices would typically be connected to the processing unit 402 by means of a peripheral interface 438 which, in turn, would be coupled to bus 406. Input devices may be directly or indirectly connected to processor 402 via interfaces such as, for example, a parallel port, game port, firewire, or a universal serial bus (USB). To view information from the computing system environment 400, a monitor 440 or other type of display device may also be connected to bus 406 via an interface, such as via video adapter 424. In addition to the monitor 440, the computing system environment 400 may also include other peripheral output devices, not shown, such as speakers and printers.

The computing system environment 400 may also utilize logical connections to one or more computing system environments. Communications between the computing system environment 400 and the remote computing system environment may be exchanged via a further processing device, such a network router 448, that is responsible for network routing. Communications with the network router 448 may be performed via a network interface component 444. Thus, within such a networked environment, e.g., the Internet, World Wide Web, LAN, or other like type of wired or wireless network, it will be appreciated that program modules depicted relative to the computing system environment 400, or portions thereof, may be stored in the memory storage device(s) of the computing system environment 400.

The computing system environment 400 may also include localization hardware 446 for determining a location of the computing system environment 400. In embodiments, the localization hardware 446 may include, for example only, a GPS antenna, an RFID chip or reader, a WiFi antenna, or other computing hardware that may be used to capture or transmit signals that may be used to determine the location of the computing system environment 400.

The computing system 400, or one or more portions thereof, may embody API upgrade system, proprietor user systems 106, end user computing devices 116, and/or another system, in some embodiments.

In a first aspect of the present disclosure, a computer-implemented method is provided that includes receiving, by a computing system associated with a web service, an application programming interface (API) call within the web service originating from a user source, determining, by the computing system based on the received API call, a version of the API in use by the user, determining, by the computing system, that a newer version of the API is available, and in response to determining the version of the API in use by the user and to determining that the newer version of the API is available, automatically causing the user to upgrade to the newer version of the API.

In an embodiment of the first aspect, the computer-implemented method further includes retrieving, by the computing system, system information respective of the user from a registry of the web service, wherein determining that a newer version of the API is available includes determining that a newer version of the API that is compatible with the system information is available.

In an embodiment of the first aspect, the API call is received by the web service via a first channel, the first channel supporting a first user interface for the user, and the method further includes retrieving, by the computing system, system information respective of the user from a registry of the web service, determining a second channel for accessing the web service that is compatible with the system information, and causing the user to install an API for making call to the web service via the second channel.

In an embodiment of the first aspect, the API is for integrating the web service into a user webpage.

In an embodiment of the first aspect, the computer-implemented method further includes determining system information respective of the user, based on the determined system information, determining an installation procedure for the newer version of the API, and transmitting the installation procedure to the user. In a further embodiment of the first aspect, determining the installation procedure includes generating a prompt to a large language model (LLM) based on the determined system information and receiving the installation procedure as output from the LLM.

In an embodiment of the first aspect, the computer-implemented method further includes determining, by the computing system, a set of functional differences between the newer version of the API and the version of the API in use by the user, wherein causing the user to upgrade to the newer version of the API is further in response to determining the set of functional differences.

In a second aspect of the present disclosure, a computer-implemented method is provided that includes receiving, by a computing system, an indication that a user is eligible to upgrade a version of an application programming interface (API) for a web service, automatically retrieving, by the computing system, system information respective of the user, automatically generating, by the computing system, a prompt to a large language model (LLM) based on the system information and the API version to cause the LLM to generate installation instructions for the API version, receiving, from the LLM, in response to the prompt, installation instructions, generating a user interface associated with the web service, and outputting the installation instructions via the user interface in response to receiving the indication.

In an embodiment of the second aspect, the computer-implemented method further includes automatically retrieving, by the computing system, internal support ticket records respective of the API version, wherein generating the prompt is further based on the retrieved internal support ticket records.

In an embodiment of the second aspect, the computer-implemented method further includes automatically retrieving, by the computing system, public forum posts respective of the API version, wherein generating the prompt is further based on the retrieved public forum posts.

In an embodiment of the second aspect, the computer-implemented method further includes accessing a codebase respective of the API version, wherein generating the prompt is further based on the codebase and is further to cause the LLM to generate integration code for the API version.

In an embodiment of the second aspect, the user interface includes a chat interface.

In an embodiment of the second aspect, the computer-implemented method further includes determining one or more third party network platforms through which the user accesses the web service via the API, wherein generating the prompt is further based on the one or more third party network platforms.

In a third aspect of the present disclosure, a computer-implemented method is provided that includes receiving, by a computing system associated with a web service, an application programming interface (API) call within the web service originating from a third party, determining, by the computing system based on the received API call, a version of the API in use by the third party, determining, by the computing system, that a newer version of the API is available, automatically retrieving, by the computing system, system information respective of the third party, automatically generating, by the computing system, a prompt to a large language model (LLM) based on the system information and the API version to cause the LLM to generate installation instructions for the API version, receiving, from the LLM, in response to the prompt, installation instructions, generating a user interface associated with the web service, and in response to determining the version of the API in use by the third party and to determining that the newer version of the API is available, automatically causing the third party to upgrade to the newer version of the API, wherein the causing includes outputting the installation instructions via the user interface.

In an embodiment of the third aspect, determining that the newer version of the API is available is further based on the retrieved system information respective of the third party.

In an embodiment of the third aspect, the API is for integrating the web service into a webpage of the user.

In an embodiment of the third aspect, the API is for integrating the web service into a third party network platform.

In an embodiment of the third aspect, determining that a newer version of the API is available includes determining that a newer version of the API that is compatible with the system information is available.

In an embodiment of the third aspect, the computer-implemented method further includes determining, based on the retrieved system information, a second channel for accessing the web service that is compatible with the system information, and causing the user to install an API for making calls to the web service via the second channel.

In an embodiment of the third aspect, the computer-implemented method further includes accessing a codebase respective of the API version, wherein generating the prompt is further based on the codebase and is further to cause the LLM to generate integration code for the API version.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system’s registers and memories and is transformed into other data similarly represented as physical quantities within the computer system memories or registers, or other such information storage, transmission, or display devices as described herein or otherwise understood to one of ordinary skill in the art.

What is claimed is:

1. A computer-implemented method comprising:
receiving, by a computing system associated with a web service, an application programming interface (API) call within the web service originating from a user source;
determining, by the computing system based on the received API call, a version of the API in use by the user;
determining, by the computing system, that a newer version of the API is available; and
in response to determining the version of the API in use by the user and to determining that the newer version of the API is available, automatically causing the user to upgrade to the newer version of the API.

2. The computer-implemented method of claim 1, further comprising:
retrieving, by the computing system, system information respective of the user from a registry of the web service;
wherein determining that a newer version of the API is available comprises determining that a newer version of the API that is compatible with the system information is available.

3. The computer-implemented method of claim 1, wherein:
the API call is received by the web service via a first channel, the first channel supporting a first user interface for the user; and
the method further comprises:
retrieving, by the computing system, system information respective of the user from a registry of the web service;
determining a second channel for accessing the web service that is compatible with the system information; and
causing the user to install an API for making call to the web service via the second channel.

4. The computer-implemented method of claim 1, wherein the API is for integrating the web service into a user webpage.

5. The computer-implemented method of claim 1, further comprising:
determining system information respective of the user;
based on the determined system information, determining an installation procedure for the newer version of the API; and
transmitting the installation procedure to the user.

6. The computer-implemented method of claim 5, wherein:
determining the installation procedure comprises generating a prompt to a large language model (LLM) based on the determined system information and receiving the installation procedure as output from the LLM.

7. The computer-implemented method of claim 1, further comprising:
determining, by the computing system, a set of functional differences between the newer version of the API and the version of the API in use by the user;
wherein causing the user to upgrade to the newer version of the API is further in response to determining the set of functional differences.

8. A computer-implemented method comprising:
receiving, by a computing system, an indication that a user is eligible to upgrade a version of an application programming interface (API) for a web service;
automatically retrieving, by the computing system, system information respective of the user;
automatically generating, by the computing system, a prompt to a large language model (LLM) based on the system information and the API version to cause the LLM to generate installation instructions for the API version;
receiving, from the LLM, in response to the prompt, installation instructions;
generating a user interface associated with the web service; and
outputting the installation instructions via the user interface in response to receiving the indication.

9. The computer-implemented method of claim 8, further comprising:
automatically retrieving, by the computing system, internal support ticket records respective of the API version;
wherein generating the prompt is further based on the retrieved internal support ticket records.

10. The computer-implemented method of claim 8, further comprising:
automatically retrieving, by the computing system, public forum posts respective of the API version;
wherein generating the prompt is further based on the retrieved public forum posts.

11. The computer-implemented method of claim 8, further comprising:
accessing a codebase respective of the API version;
wherein generating the prompt is further based on the codebase and is further to cause the LLM to generate integration code for the API version.

12. The computer-implemented method of claim 8, wherein the user interface comprises a chat interface.

13. The computer-implemented method of claim 8, further comprising:
determining one or more third party network platforms through which the user accesses the web service via the API;
wherein generating the prompt is further based on the one or more third party network platforms.

14. A computer-implemented method comprising:
receiving, by a computing system associated with a web service, an application programming interface (API) call within the web service originating from a third party;
determining, by the computing system based on the received API call, a version of the API in use by the third party;
determining, by the computing system, that a newer version of the API is available;
automatically retrieving, by the computing system, system information respective of the third party;
automatically generating, by the computing system, a prompt to a large language model (LLM) based on the system information and the API version to cause the LLM to generate installation instructions for the API version;
receiving, from the LLM, in response to the prompt, installation instructions;
generating a user interface associated with the web service; and
in response to determining the version of the API in use by the third party and to determining that the newer version of the API is available, automatically causing the third party to upgrade to the newer version of the API, wherein the causing comprises outputting the installation instructions via the user interface.

15. The computer-implemented method of claim 14, wherein determining that the newer version of the API is available is further based on the retrieved system information respective of the third party.

16. The computer-implemented method of claim 14, wherein the API is for integrating the web service into a webpage of the user.

17. The computer-implemented method of claim 14, wherein the API is for integrating the web service into a third party network platform.

18. The computer-implemented method of claim 14, wherein determining that a newer version of the API is available comprises determining that a newer version of the API that is compatible with the system information is available.

19. The computer-implemented method of claim 14, further comprising:
determining, based on the retrieved system information, a second channel for accessing the web service that is compatible with the system information; and
causing the user to install an API for making calls to the web service via the second channel.

20. The computer-implemented method of claim 14, further comprising:
accessing a codebase respective of the API version;
wherein generating the prompt is further based on the codebase and is further to cause the LLM to generate integration code for the API version.
